(19) United States
(12) Patent Application Publication
(10) Pub. No.: US 2017/0256172 A1
(43) Pub. Date: Sep. 7, 2017

(54) STUDENT DATA-TO-INSIGHT-TO-ACTION-TO-LEARNING ANALYTICS SYSTEM AND METHOD

(71) Applicant: CIVITAS LEARNING, INC., Austin, TX (US)

(72) Inventors: David H. Kil, Austin, TX (US); Kyle Derr, Austin, TX (US); Mark Whitfield, Brooklyn, NY (US); Grace Eads, Austin, TX (US); John M. Daly, Round Rock, TX (US); Clayton Gallaway, Cedar Park, TX (US); Jorgen Harmse, Austin, TX (US); Daya Chinthana Wimalasuriya, Round Rock, TX (US)

(73) Assignee: CIVITAS LEARNING, INC., Austin, TX (US)

(21) Appl. No.: 15/451,147

(22) Filed: Mar. 6, 2017

Related U.S. Application Data
(60) Provisional application No. 62/303,970, filed on Mar. 4, 2016.

(51) Int. Cl. G09B 5/02; G09B 19/00; G09B 5/00; G06Q 10/06; G06Q 50/20

(52) U.S. Cl. CPC G09B 5/02; G06Q 10/06393; G06Q 50/205; G09B 5/00; G09B 19/00

(57) ABSTRACT

Student data-to-insight-to-action-to-learning analytics system and method use an evidence-based action knowledge database to compute student success predictions, student engagement predictions, and student impact predictions to interventions. The evidence-based action knowledge database is updated by executing a multi-tier impact analysis on impact results of applied interventions. The multi-tier impact analysis includes using changes in key performance indicators (KPIs) for pilot students after each applied intervention and dynamic matching of the pilot students exposed to the appropriate interventions to other students who were not exposed to the appropriate interventions.

### CROSS REFERENCE TO RELATED APPLICATION

This application is entitled to the benefit of U.S. Provisional Patent Application Ser. No. 62/303,970, filed on Mar. 4, 2016, which is incorporated herein by reference.

### BACKGROUND OF THE INVENTION

The world is awash in data, but potential cherry picking and human bias can present challenges in interpreting data and taking actions (Sullivan, 2015). In healthcare, Greene (2011) discusses the use of evidence-based medicine (EBM) guidelines from a vast collection of medical journals to improve the standard of care. However, EBM guidelines derived from an average randomized patient of various eligibility criteria are neither precise nor detailed or replicated enough to impact cost-adjusted patient outcomes in the real world (Feinstein, 1997; Woolf et al., 1999). Furthermore, most published research findings suffer from positive bias (Ioannidis, 2005; Littell 2008; Song et al., 2010).

In higher education, the What Works Clearinghouse (WWC) maintains a comprehensive list of publications with its own ratings, where randomized controlled trials (RCT) and studies with baseline-matched quasi-experimental design (QED) receive endorsements with and without reservations, respectively (WWC, 2016). Unfortunately, most studies do not receive any endorsement due to significant problems with experimental design. Furthermore, even publications with endorsements suffer from the same issues that befall their brethren EBM publications in healthcare.

### SUMMARY OF THE INVENTION

Student data-to-insight-to-action-to-learning analytics system and method use an evidence-based action knowledge database to compute student success predictions, student engagement predictions, and student impact predictions to interventions. The evidence-based action knowledge database is updated by executing a multi-tier impact analysis on impact results of applied interventions. The multi-tier impact analysis includes using changes in key performance indicators (KPIs) for pilot students after each applied intervention and dynamic matching of the pilot students exposed to the appropriate interventions to other students who were not exposed to the appropriate interventions.

A student data-to-insight-to-action-to-learning analytics method in accordance with an embodiment of the invention comprises computing student success predictions, student engagement predictions, and student impact predictions to interventions using at least linked-event features from multiple student event data sources and an evidence-based action knowledge database, the linked-event features including student characteristic factors that are relevant to student success, applying appropriate interventions to pilot students when engagement rules are triggered, the engagement rules being based on at least the linked-event features and multi-modal student success prediction scores, and executing a multi-tier impact analysis on impact results of the applied interventions to update the evidence-based action knowledge database, the multi-tier impact analysis including using changes in key performance indicators (KPIs) for the pilot students after each applied intervention and dynamic matching of the pilot students exposed to the appropriate interventions to other students who were not exposed to the appropriate interventions. In some embodiments, the steps of this method are performed when program instructions contained in a computer-readable storage medium are executed by one or more processors.

A student data-to-insight-to-action-to-learning analytics system in accordance with an embodiment of the invention comprises memory and a processor, which is configured to compute student success predictions, student engagement predictions, and student impact predictions to interventions using at least linked-event features from multiple student event data sources and an evidence-based action knowledge database, the linked-event features including student characteristic factors that are relevant to student success, apply appropriate interventions to pilot students when engagement rules are triggered, the engagement rules being based on at least the linked-event features and multi-modal student success prediction scores, and execute a multi-tier impact analysis on impact results of the applied interventions to update the evidence-based action knowledge database, the multi-tier impact analysis including using changes in key performance indicators (KPIs) for the pilot students after each applied intervention and dynamic matching of the pilot students exposed to the appropriate interventions to other students who were not exposed to the appropriate interventions.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a student data-to-insight-to-action-to-learning analytics system in accordance with an embodiment of the invention

FIG. 2 shows a table with examples of linked-event features divided into seven (7) categories in accordance with an embodiment of the invention.

FIG. 3 shows components of a micro intervention delivery sub-system in accordance with an embodiment of the invention.

FIG. 4 shows a mapping between three engagement rules based on linked events and KPIs in accordance with an embodiment of invention.

FIG. 5 shows components of a tier-1 impact analysis module in accordance with an embodiment of the invention.

FIG. 6 shows components of a tier-2 impact analysis module in accordance with an embodiment of the invention.

FIG. 7 shows a diagram of two different type nudges for students over term days.

FIG. 8 shows an example of a tier-2 analysis for nudging in accordance with an embodiment of the invention.

FIG. 9 shows conditional probability table (CPT) cells in accordance with an embodiment of the invention.

FIG. 10 shows components of a tier-3 impact analysis module in accordance with an embodiment of the invention.

FIG. 11 depicts a bar chart showing number of pilot and control students during academic calendar terms.

FIG. 12 shows different learning algorithms that can be used by the tier-3 impact analysis module.

FIG. 13 shows a simple threshold-based matching in success prediction and intervention propensity dimensions.

FIG. 14 shows representative data samples from the tier-1 impact analysis module that can be used to build student engagement and impact models.

FIG. 15 shows a block diagram of a nudge delivery subsystem in accordance with an embodiment of the invention.

FIG. 16 depicts a homepage that illustrate how connected, predictive, and action insights can be communicated to various stakeholders to create a virtuous circle in accordance with an embodiment of the invention.

FIG. 17 depicts a drill-down initiative page in accordance with an embodiment of the invention.

FIG. 18 shows an example of a real-time student success program impact dashboard that can be provided by the student data-to-insight-to-action-to-learning analytics system.

FIG. 19 is a process flow diagram of a student data-to-insight-to-action-to-learning analytics method in accordance with an embodiment of the invention.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

In higher education, there is an urgent need for a data-driven, evidence-based action knowledge database that has the following characteristics:
1. Fully connected insight-to-action pathways encoding 5W's and 1H—who (success prediction score), why (context through linked event features), when (predicting when to reach out for engagement), what (outreach), where (location-based action), and how (tonality and focus of nudges)
2. More sophisticated impact analyses that can provide action results at multiple levels of granularity for corroborating evidence to facilitate more student-level, personalized, highly effective actions based on continuous learning while untangling interferences from multiple concurrent interventions.

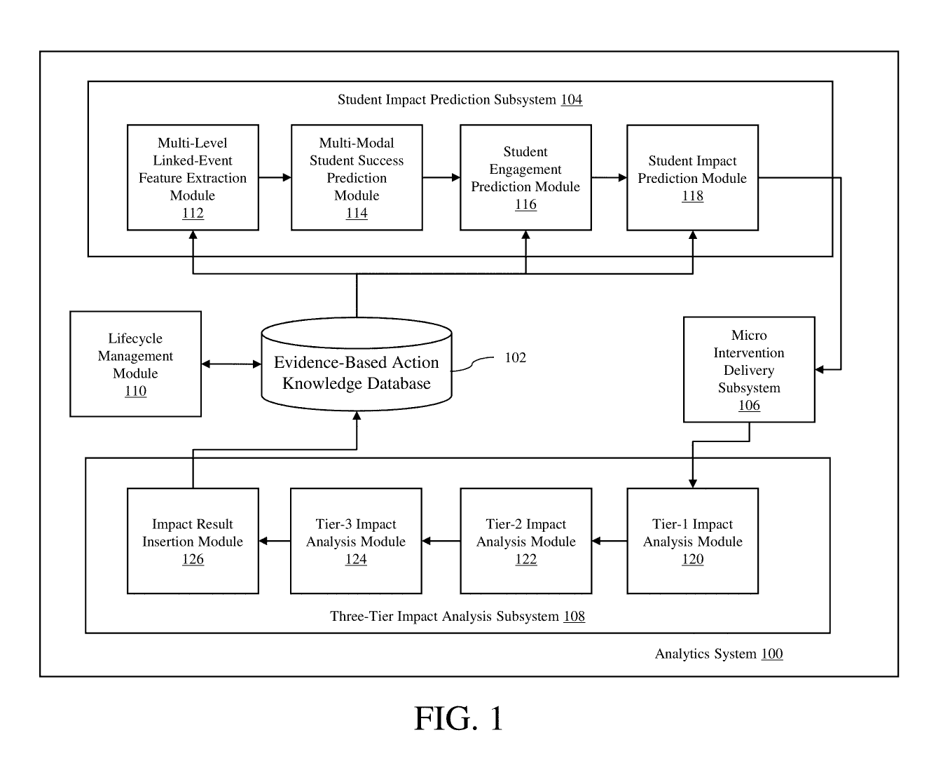

Turning now to FIG. 1, a student data-to-insight-to-action-to-learning analytics system 100 in accordance with an embodiment of the invention is shown. The analytics system 100 provides a data-driven, evidence-based action knowledge database 102, which has the above-described characteristics. As illustrated in FIG. 1, the analytics system 100 includes a student impact prediction subsystem 104, a micro intervention delivery subsystem 106, an impact analysis subsystem 108, and a lifecycle management module 110.

As shown in FIG. 1, the student impact prediction subsystem 104 includes a multi-level linked-event feature extraction module 112, a multi-modal student success prediction module 114, a student engagement prediction module and a student impact prediction module 118. These components of the student impact prediction subsystem 104 can be implemented as software, hardware or a combination of software and hardware. In some embodiments, at least some of these components of the student impact prediction subsystem 104 are implemented as one or more software programs running in one or more computer systems using one or more processors and memories associated with the computer systems. These components may reside in a single computer system or distributed among multiple computer systems, which may support cloud computing.

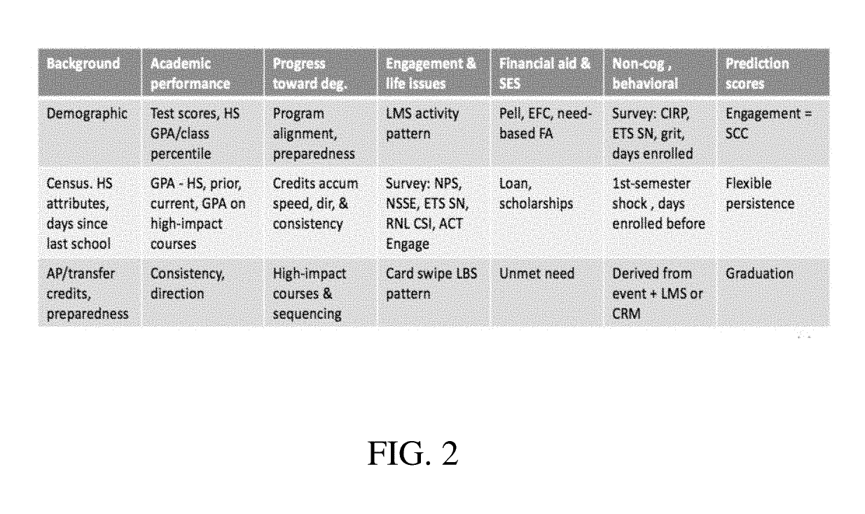

The multi-level linked-event feature extraction module 112 provides the answer to the why question. For example, feature analysis shows new students with high ACT or SAT scores tend to persist at a lower rate when these students perform poorly on their mid-term exams. Furthermore, how they bounce back from such adversities can be a strong indicator of grit and future success. Such linked-event features can be systematically analyzed in terms of their predictive power, interpretability, engagement, and impact. FIG. 2 shows a table with examples of linked-event features divided into seven (7) categories in accordance with an embodiment of the invention.

As illustrated in FIG. 2, the examples of linked-event features include background features, academic-performance features, progress-towards-degree features, engagement and life issue features, financial and socioeconomic status (SES) features, non-cognitive and inferred behavioral features and prediction scores. The background features describe student characteristics at time of entry. The academic-performance features provide insights into how students perform in various courses over time while the progress-towards-degree features keep track of how students are doing in terms of taking the right courses in the right sequence to graduate in time. The engagement and life issue features leverage Learning Management System (LMS), passive sensing, Location-Based Services (LBS) data, and various assessment data to characterize students' engagement and social/psychological factors important for success. The financial and SES features provide insights into the role financial aid and SES play in influencing student success. The non-cognitive and inferred behavioral features focus on hidden factors that can influence prediction scores in a meaningful way. The prediction scores can be considered as uber predictors since they combine all of these features to provide the best estimates of student success.

Using such real-time linked-event features coupled with background information, the multi-modal student success prediction module 114 next predicts student success in multiple dimensions, such as, but not limited to, academic success, persistence, switching majors, time to and credits at graduation, and post-graduation success. By virtue of having a different subset of top predictors during various stages of a student's academic journey, higher-education (HE) institutions can develop more timely and context-aware student outreach programs and policies, aided by the three-tier impact analysis engine to be described shortly.

The multi-modal student success prediction models generated by the multi-modal student success prediction module 114 produce multidimensional student success scores (Kil et al., 2015). By virtue of competing and selecting top features for various models built for different student segments, the answer to why students have such prediction scores can also be explained.

Engagement and impact predictions made by the student engagement prediction module 116 and the student impact prediction module 118 complete the hierarchical three-level prediction cycle that connects predictive insights to actions to results. These predictions require the analysis results of the impact analysis subsystem 108 with a particular emphasis on parameterization of intervention, student, and prediction characteristics.

In general, the student engagement prediction module 116 works by evaluating engagement rules in terms of their effect on short-term student success metrics. Engagement rules are expressed in terms of linked-event features and prediction scores to isolate opportune moments for reaching out to students. Impact prediction made by the student impact prediction module 118 is predicated on an intervention program utility score table as a function of engagement rules, interventions, and student characteristics. The utility score table is populated with the results from the impact analysis subsystem 108. The student engagement prediction module 116 and the student impact prediction module 118 are described in more detail below.

The micro intervention delivery subsystem 106 operates to deliver micro interventions when one or more engagement rules have been triggered due to incoming data from multiple student event data sources. The micro intervention delivery subsystem 106 will be described in more detail below.

The three-tier impact analysis subsystem 108 operates to look for results of delivered micro interventions in several time scales using three-tier analyses. The tier-1 real-time analysis looks for an immediate change in, but not limited to, a student's activities, behavior, sentiment, stress level, location, and social network structure that are attributable to and/or consistent with the expected results of just-delivered micro interventions at the student level. The tier-2 analysis aggregates all students who received similar micro interventions at some time scale (hourly or daily or weekly) so that it can create on-the-fly pilot and control groups using dynamic baseline matching with exponential time fading for freshness in reported results. The tier-3 impact analysis measures the results of students exposed to various micro interventions using term-level metrics, such as, but not limited to, semester grade point average (GPA), successful course completion, engagement, persistence, graduation, job placement, and salary.

The evidence-based action knowledge database 102 works in concert with the lifecycle management subsystem 110 to ensure that engagement and impact strategies reflect only the best evidence-based practices over time as student characteristics and intervention strategies change over time. The evidence-based action knowledge database 102 and the lifecycle management subsystem 110 are described in more detail below.

In order to further describe the components of the student data-to-insight-to-action-to-learning analytics system 100 in a clear manner, the following key terms are defined.
1. Pilot or intervention program: A pilot or intervention program refers to a high-level student success initiative targeting a specific group of students.
2. Treatment or micro intervention: A student in a pilot program can receive treatment or micro intervention defined as contact between a student and an institutional entity encompassing, but not limited to, faculty, advisors, administrators, student mentors/mentees, and personal digital Sherpas or guides. Some may receive multiple micro interventions while others may receive nothing despite all of them belonging to a pilot program. A treatment can be delivered in the form of SMS nudge, email, automatic voice call, phone call, in-person meeting, etc.
3. Linked-event features: Most predictive models predict who is at risk while revealing very little about what action can be taken to lower risk. These features, as depicted in FIG. 2, provide the right contextual information so the user/virtual coach feels comfortable with both taking an action and driving the right conversation.
4. Engagement rules: James (2013) explains the importance of patient engagement in influencing healthcare outcomes. Engagement rules, consisting of recent events and linked-event features, represent our understanding of when to reach out or apply treatment to students for both engagement and success. That is, linked-event features facilitate context-aware micro interventions while recent events represent opportune moments for delivering micro interventions. In short, engagement rules facilitate the optimization of intervention timing.
5. Triggers: Triggers represent engagement rules selected to deliver micro interventions based on prioritization in case multiple engagement rules are fired. Prioritization is based on impact potential and triggers fired within a recent time period in order to minimize trigger duplication within a short period of time.
6. Key performance indicators (KPIs): KPIs are data-driven metrics by which we assess whether or not treatment has been effective within a short time period.
7. Conditional probability table (CPT): The conditional probability table is constructed from multiple variables, where the variables are hierarchically organized. For example, let's say the GPA feature has high, medium, and low categories. There are also have part-time and full-time students based on credits attempted per semester. In this simple case, there would be a table of 2×3 with six CPT cells, i.e., students with low GPA and part time, low GPA and full time, medium GPA and part time, medium GPA and full time, high GPA and part time, and high GPA and full time.
8. Rubik's hypercube or CPT cell: For >2 variables, the same CPT can be expanded to include all the variables. Rubik's hypercube is a metaphor for CPT with a number of cells.

In the following detailed description of the student data-to-insight-to-action-to-learning analytics system 100, the micro intervention delivery subsystem 106 will be first described and then the impact analysis subsystem 108 will be described, followed by the evidence-based action knowledge database 102 and the lifecycle management module 110. Finally, the student impact prediction subsystem 104 will be described with respect to the student engagement prediction module 116 and the student impact prediction module 118.

The micro intervention delivery sub-system 106 operates to systematically evaluate a number of engagement rules and rank them in terms of impact potential (IP). In an embodiment, the IP for an engagement rule is calculated as follows:

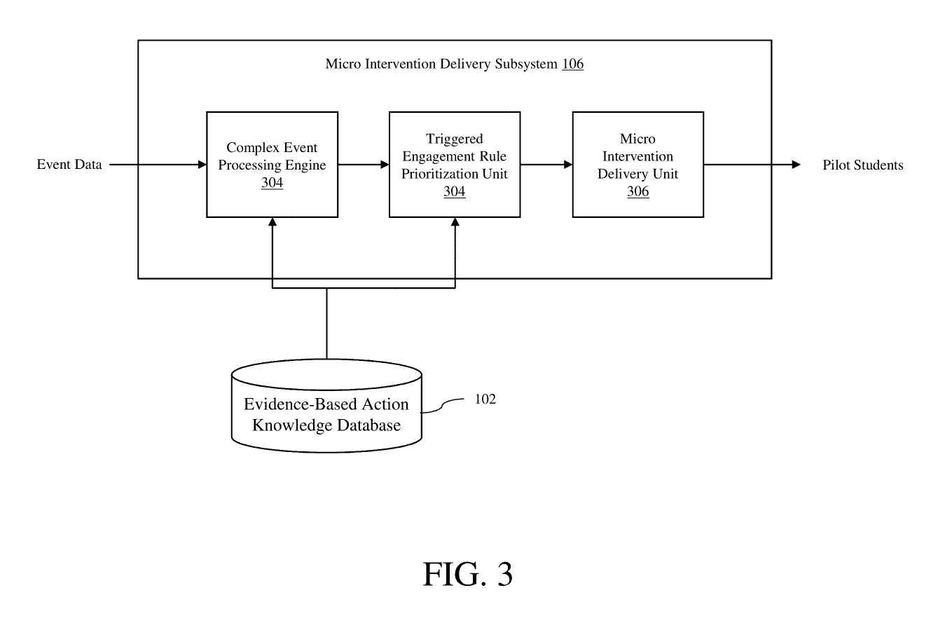

IP_{ER}_{ᵢ}=Nᵢ(p_{avg}−pᵢ), Equation 1

where Nᵢ is the number of students triggered by ERi while p_{avg} and pᵢ refer to the average prediction score of students triggered by the prediction score filter alone and the average prediction score of students triggered by ERᵢ, respectively. The micro intervention delivery subsystem 106 then facilitates delivery of an appropriate micro intervention corresponding to the highest ranked engagement rule. As shown in FIG. 3, the micro intervention delivery sub-system 106 includes a complex event processing (CEP) engine 302, a triggered engagement rule prioritization unit 304, a micro intervention delivery unit 306 in accordance with an embodiment of the invention.

The CEP engine 306 listens to or monitors incoming streams of event data from multiple sources, such as, but not limited to, Student Information System, Learning Management System, Customer Management Relationship System, card swipe, smartphone applications, and passive sensing, to detect if their patterns match any prescribed engagement rules via rule-condition matching. If multiple engagement rules get triggered, the triggered engagement rule prioritization unit 304 prioritizes the engagement rules based on their utility scores and intersection with the recently fired/triggered engagement rules, e.g., using equation 1, to identify the highest rated engagement rule to ensure that the student gets the nudge from the most engaging and recently unused engagement rule triggered. The prioritization of triggered engagement rules is necessary to eliminate too-frequent micro interventions based on the number of triggers and the last micro intervention timestamp.

The micro intervention delivery unit 306 then automatically delivers an intervention corresponding to the highest-rated engagement rule to pilot students for which the highest-rated engagement rule has been triggered. For example, if the engagement rule is that a student didn't do well on a midterm exam of a high-impact course, such as English composition, then the micro intervention is to nudge the student to go to a writing center, where he can work with a tutor to improve his writing skills, which is very important for his junior and senior courses with term paper requirements. The types of micro interventions may include, but not limited to, SMS nudge, email, automatic voice call, phone call, in-person meeting, etc.

Turning back to FIG. 1, the three-tier impact analysis sub-system 108 includes a tier-1 impact analysis module 120, a tier-2 impact analysis module 122, a tier-3 impact analysis module 124 and an impact result packing module 126. These components of the three-tier impact analysis sub-system 108 can be implemented as software, hardware or a combination of software and hardware. In some embodiments, at least some of these components of the three-tier impact analysis sub-system 108 are implemented as one or more software programs running in one or more computer systems using one or more processors and memories associated with the computer systems. These components may reside in a single computer system or distributed among multiple computer systems, which may support cloud computing.

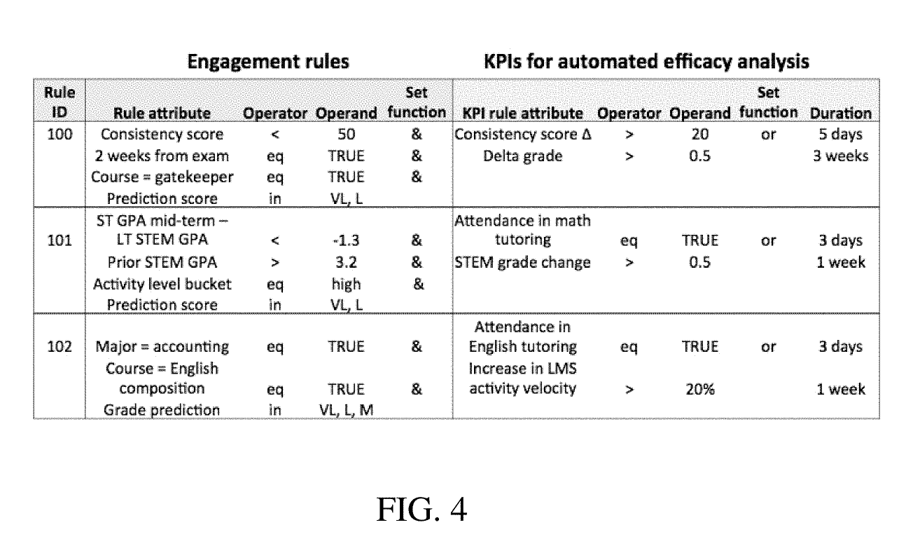

The tier-1 impact analysis module 120 operates to perform an impact analysis using mapping between engagement rules and short-term outcomes metrics called key performance indicators (KPIs), such as, but not limited to, improving consistency in efforts before exams instead of cramming, going to a tutoring center as nudged after a poor midterm exam, registering early for next term for better preparation coming in, and participating in discussion boards to share ideas for those who have not participated in the past two weeks. As an example, FIG. 4 shows a mapping between three engagement rules based on linked events and KPIs in accordance with an embodiment of the invention. The tier-1 impact analysis module 120 keeps track at the student level of triggered engagement rules, characteristics of micro-interventions intervention-delivery modalities, KPI values post micro interventions, student characteristics, and institutional parameters so that impact of the triggered engagement rules can be properly characterized.

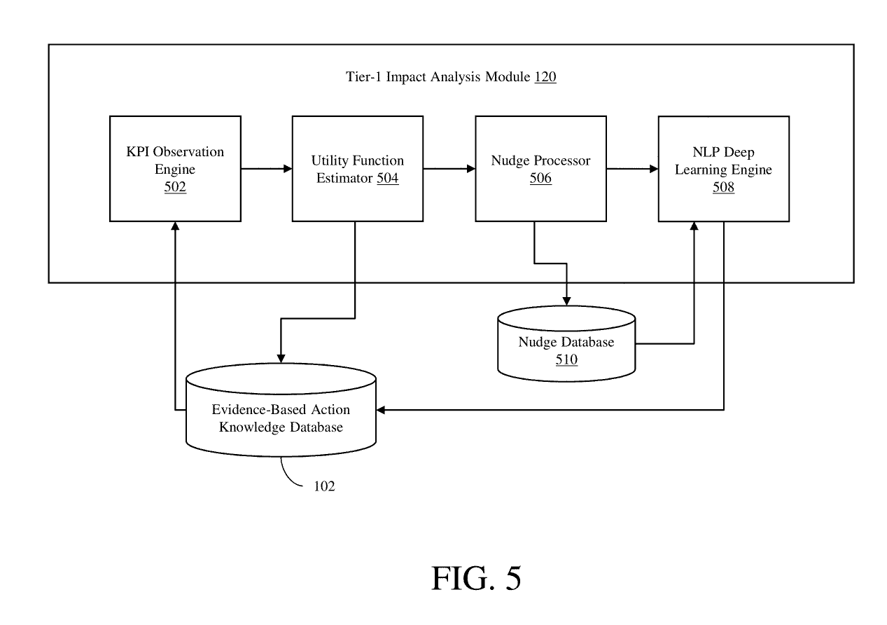

Turning now to FIG. 5, components of the tier-1 impact analysis module 120 in accordance with an embodiment of the invention are shown. As shown in FIG. 5, the tier-1 impact analysis module 120 includes a KPI observation engine 502, a utility function estimator 504, a nudge processor 506 and a natural language processing (NLP) deep learning engine 508. As illustrated in FIG. 5, the tier-1 impact analysis module 112 uses the evidence-based action knowledge database 102 to retrieve information, such as KPIs and applied micro intervention information, and to store results of the analysis performed by the tier-1 impact analysis module.

After the micro interventions have been delivered to the pilot students, the KPI observation engine 502 looks for changes in incoming streams of data consistent with KPI specifications, such as those shown in FIG. 4, from the evidence-based action knowledge database 102 for the triggered engagement rule-micro intervention pair. The utility function estimator 504 calculates the utility score Uᵢ associated with the triggered engagement rule-micro intervention pair characterized by ERᵢ using a sigmoid function

$${U}_{i} ( x ) = \frac{1}{1 + {e}^{- x}} ,$$

where x is an appropriately scaled version of change in KPI. If KPIs are combined using the OR operator, the utility function estimator 310 can take the average or max of Uᵢ(x) over multiple KPIs. If KPIs are combined using the AND operator, then the utility function estimator 310 can use the equation,

$${U}_{i} ( x ) = 1 / ( 1 + exp ( - \frac{1}{{N}_{KPI}} {\sum }_{k = 0}^{{N}_{KPI}} {x}_{k} ) ) ,$$

to compute the utility score.

For binary KPIs, such as attendance in a math tutoring session, where x=1 if attended and x=−1 otherwise, the utility score will be either 0.7311 or 0.2689. For continuous KPIs, such as consistency score, the utility function estimator 310 first plots the probability density function of delta consistency score. Conceptually, the higher the delta consistency score, meaning that a micro intervention designed to improve a student's effort consistency has improved the student's level of effort consistently, the higher the utility score. Next, the utility function estimator 310 apply a shaping function s(·) (e.g., the sigmoidal nonlinear function) such that the delta consistency KPI values are mapped to an appropriate region in x for utility computation. The utility score Uᵢ is stored in the evidence-based action knowledge database 102.

If the delivered micro interventions are in the form of message nudges, i.e., written messages delivered through SMS or email, the nudge processor 506 pairs the nudges to KPIs and transmit the information to the NLP deep learning engine 506. The nudge processor 506 also stores the textual content of the message nudge and the utility score of the message nudge. In an embodiment, the nudge processor 506 stores the information in a nudge database 510, which is separate from the evidence-based action knowledge database 102. In other embodiments, the nudge processor 506 may store the information in the evidence-based action knowledge database 102 or another database. The NLP deep learning engine 508 performs natural language processing on the delivered nudge using information in the nudge database 510 from previous delivered nudges to learn the characteristics of effective and ineffective messages through a combination of supervised and deep learning. The NLP deep learning engine 508 extracts a number of multi-polarity sentiment and linguistic features to characterize message. Examples of sentiment features are, but not limited to, empathy, urgency, fear, achievement, challenge, encouragement, etc. while linguistic features encompass readability, length, degree of formality, the use of pronouns, and so on. Such information on what makes certain nudges effective is useful in content creation through crowdsourcing and content experts. The results of the natural language processing are stored in the evidence-based action knowledge database 102.

In short, the tier-1 impact analysis module 120 computes a utility score associated with each pair of engagement rule-micro intervention. Furthermore, the tier-1 impact analysis module 120 provides an appropriate context to enable replication with evidence. The contextual parameters encompass student characteristics, ER triggers, prior and current micro-intervention characteristics, institutional characteristics, individual KPIs, and delivery modality. The utility function is analogous to a multidimensional version of Rubik's cube.

The tier-2 impact analysis module 122 of the three-tier impact analysis subsystem 108 extends the tier-1 impact analysis module 120 by (1) aligning in time the same micro interventions or treatments applied to multiple students over time, (2) performing on-the-fly prediction-based propensity score matching (PPSM) to create dynamic pilot and control groups based on exposure to treatment at prescribed sampling interval, such as daily or weekly, and (3) estimating treatment effects through the difference-of-difference (DoD) analysis—difference between pilot and control students and difference between pre-period and post-period for a treatment—in various dimensions of Rubik's hypercube or conditional probability table (CPT) cells.

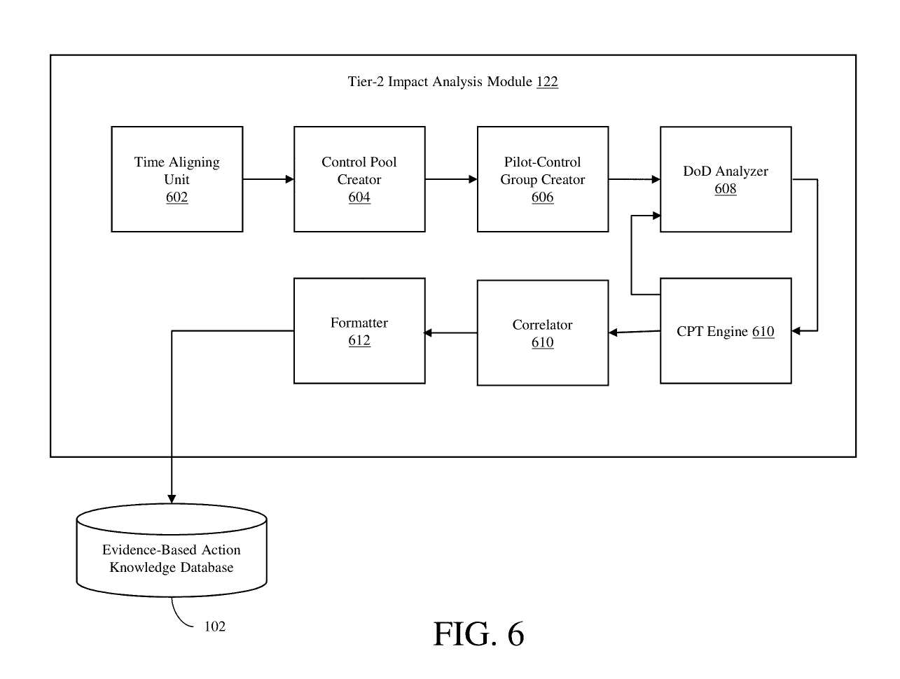

Turning now to FIG. 6, components of the tier-2 impact analysis module 122 in accordance with an embodiment of the invention are shown. As shown in FIG. 6, the tier-2 impact analysis module 122 includes a time aligner 602, a control pool creator 604, a pilot-control group creator 606, a difference-of-difference (DoD) analyzer 608, a CPT engine 610, a correlator 612 and a formatter 614. As illustrated in FIG. 6, the results of the tier-2 impact analysis module 122 are stored in the evidence-based action knowledge database 102.

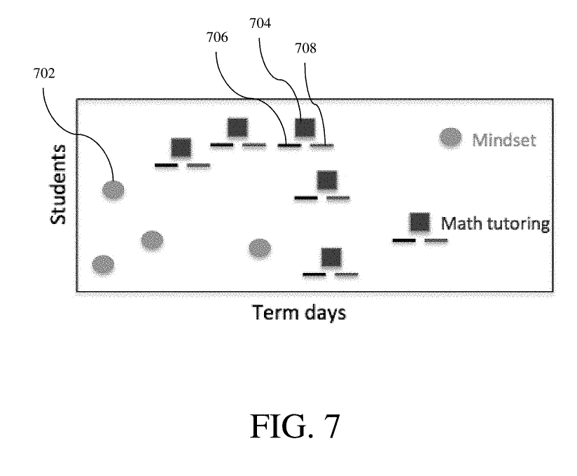

The components of the tier-2 impact analysis module 122 are described with reference to FIG. 7, which shows a diagram of two different type nudges 702 and 704 for students over term days. In FIG. 7, the circular nudges 702 correspond to SMS nudges associated with mindset coaching to improve a student's mindset from fixed to growth, i.e., “I can accomplish this task once I put my mind to it” instead of “I am born with low intelligence so whatever I do, I will fail,” while the square nudges 704 correspond to SMS nudges associated with in-person math tutoring. Each in-person math tutoring nudge 704 is show with a left line 706 and a right line 708, which denote a pre-period and a post-period, respectively, around the treatment timestamp, i.e., the timestamp of the in-person math tutoring nudge.

The time aligner 602 performs a time-alignment process, which involves aligning every day the same treatment events applied to multiple students over time so that all the events look like they took place at the same time. Thus, for the example shown in FIG. 7, the time aligner 602 would align all the mindset coaching nudges 702 to the same time and align all the in-person math tutoring nudges 704 to the same time.

The control pool creator 604 looks for control students matched to each pilot student from a pool of similar students not exposed to any treatment around the treatment timestamp for that pilot student. Baseline features during the pre-period are used in dynamic matching while KPI features during the post period become an integral part in the tier-1 impact analysis. In an embodiment, the control pool creator 604 operates with the time aligner 602 so that control students are found by the control pool creator during the time-alignment process performed by the time aligner.

The pilot-control group creator 606 performs on-the-fly baseline matching process to create groups of pilot students and control students that have similar metrics. The pilot-control student similarity metric is based on prediction score, propensity score, and any other customer-specified hard-matching covariates, such as, but not limited to, cohorts (freshmen), grad vs. undergrad, online vs. on ground, at the time of treatment event. This on-the-fly baseline matching process ensures that statistically indistinguishable pilot and control groups are identified for apples-to-apples comparison dynamically. Thus, on-the-fly pilot-control pairs are created every day using baseline features around the treatment event timestamps through time alignment and dynamic PPSM.

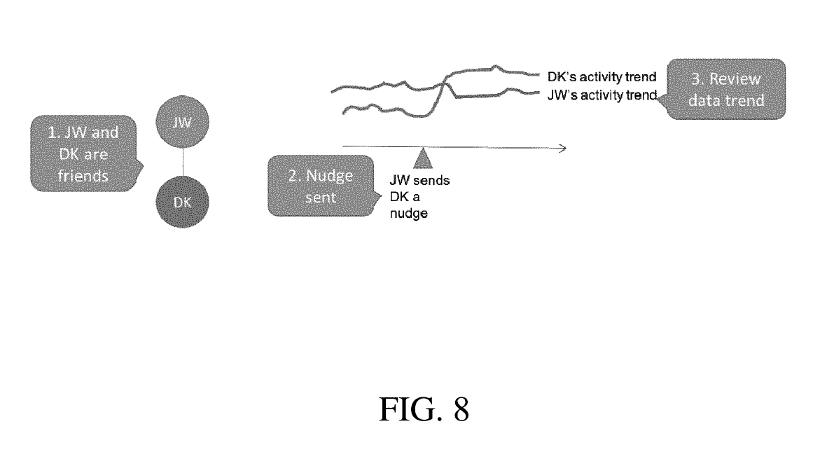

The Difference-of-Difference (DoD) analyzer 608 performs difference-of-difference (DoD) analysis with hypothesis testing for overall impact. The CPT engine 610 generates an impact number for each treatment using results of the DoD analysis. The actual impact number is estimated by computing the difference-of-difference between the pre-period and the post-period, and between the pilot students and the control students. FIG. 8 shows an example of a tier-2 analysis for nudging in accordance with an embodiment of the invention. In this case, JW sends a nudge to DK. After the nudge, the tier-2 analysis looks for change in DK's activity level before and after the nudge. At the same time, the tier-2 analysis finds another student who is comparable to DK in both prediction and propensity scores. The tier-2 analysis also monitors the matched student's activity level change. The difference-of-difference between DK's and the matched student's pre-post activity level change is the true impact of the nudge.

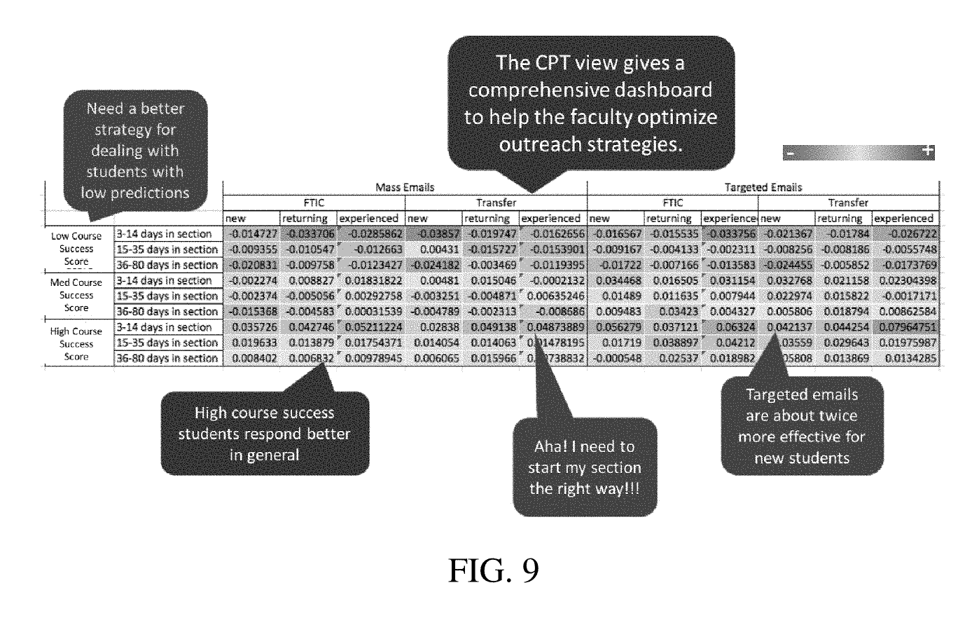

The same process can be repeated for each cell in Rubik's hypercube. Treatment dosage can be included as part of the prior and current treatment parameters. Cells can be created based on student characteristics and intervention strategies organized into conditional probability table (CPT) cells as shown in FIG. 9 in accordance with an embodiment of the invention. In FIG. 9, a 5-dimensional CPT cell is formed in course success prediction score, time of outreach since section start, type of email (mass vs. targeted), student type (first time in college or transfer), and student experience (brand new, 1-3 terms completed, 4+ terms completed at the institution). Such CPT drill-down insights were instrumental for the institution to revise intervention strategies for the bottom 1/3 students in course success prediction at the next term, which resulted in greater improvements in student success measured in successful course completion and persistence.

Next, the correlator 610 measures the correlation between tier-1 utility functions and CPT impact results to ensure that impact results are consistent across different time scales. That is, the correlator 610 computes the correlation between utility scores derived from KPIs and the impact numbers for various hypercube cells. In theory, KPIs represent micro-pathway metrics that can provide an earlier glimpse into eventual student-success outcomes. As a result, changes in KPIs should be correlated with changes in student-success and student-engagement predictions, as well as with changes in student-success outcomes. The correlation analysis performed by the correlator 610 provide an opportunity to improve the way KPIs for tier-1 analysis are constructed as well as providing confidence that the right metrics are being used to assess real-time efficacy of micro interventions.

The formatter 612 then formats the outputs of the tier-2 impact analysis, i.e., utility scores and CPT results in FIG. 9, and inserts the outputs into the evidence-based action knowledge database 102. The database table includes all CPT partitioning dimension information, impact results, the number of students in each cell, statistical significance, pilot characteristics, institutional characteristics, time and duration, and analyst annotations to make search possible.

The tier-3 impact analysis module 124 answers the final question of how much impact a pilot program has on student success at the end of a pilot term when students graduate, continue to the next term, transfer to a different school, or drop out. In short, the analysis performed by the tier-3 impact analysis module 124 is a program-level impact analysis regardless of the frequency, reach, depth, and duration of treatment during the pilot program.

Fahner (2014) describes a causal impact analysis system to determine the impact on spending of raising credit limit using standard propensity-score matching originally described in a seminal work by Rosenbaum and Rubin (1981). Kil (2011) describes an intelligent health benefit design system, where prediction- and propensity-score matching is used to assess the efficacy of various health-benefit programs in improving patient health. However, unlike financial and healthcare industries, the higher-education sector has three major challenges. First, students have a different level of digital data footprint based on terms completed, transfer status, course modalities (online vs. on ground), financial aid, and developmental education status. Second, it is not always feasible to conduct randomized controlled trials or observational studies with enough students set aside for control because of a complex nested structure of faculty teaching multiple sections within courses taken by students. Finally, because of the siloed organizational structure that leaks into data governance, there can be multiple, concurrent intervention programs as well as varying degrees of data sources from institution to institution, in part due to data governorship, readiness, and capacity.

In order to deal with these challenges, the tier-3 impact analysis module 124 has the following innovative features:
1. Automated and expert-specified student segments based on data footprint to maximize the use of available data for improved model accuracy and more precise, insightful impact measurements
2. Flexible matching of pilot and control students over different time periods, using prediction score, propensity score, and customer-specified hard-matching features based on the breadth and reach of intervention programs
3. Incorporation of concurrent intervention program participation flags for those with statistically significant outcomes in building prediction and propensity-score models

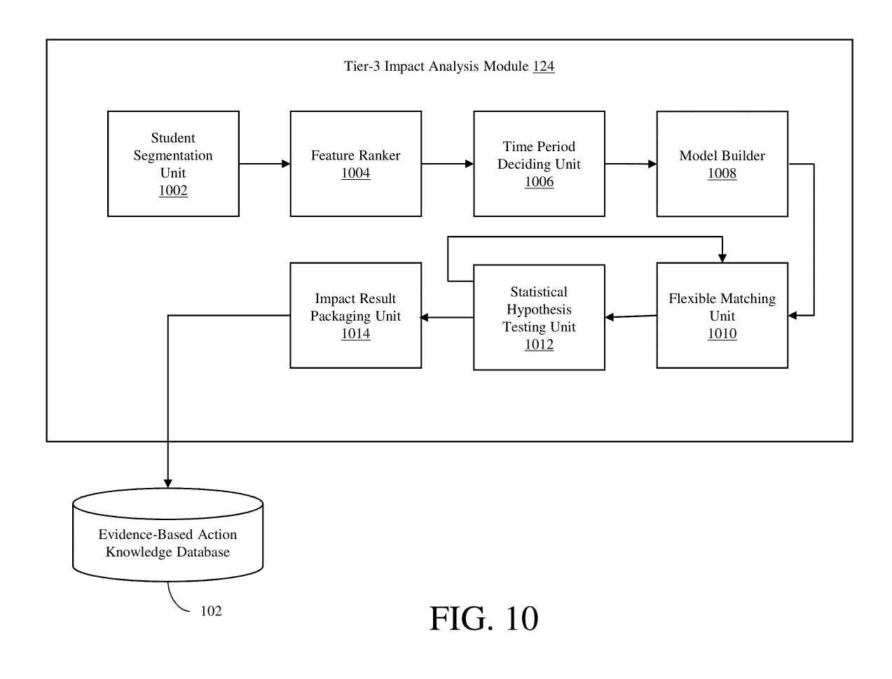

Turning now to FIG. 10, components of the tier-3 impact analysis module 124 in accordance with an embodiment of the invention are shown. As shown in FIG. 10, the tier-3 impact analysis module 124 includes a student segmentation unit 1002, a feature ranker 1004, a time period deciding unit 1006, a model builder 1008, a flexible matching unit 1010, a statistical hypothesis testing unit 1012 and an impact result packaging unit 1014. As illustrated in FIG. 10, the results of the tier-3 impact analysis module 124 are stored in the evidence-based action knowledge database 102.

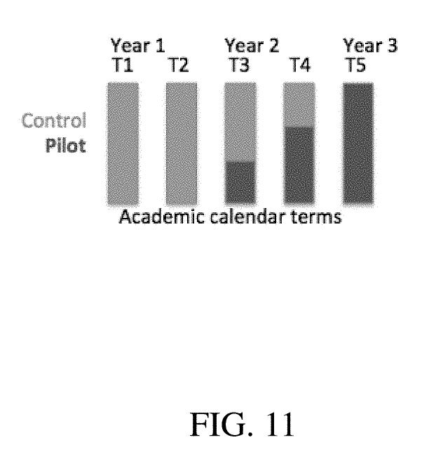

The components of the tier-3 impact analysis module 124 are described with reference to FIG. 11, which shows a bar chart showing number of pilot and control students during academic calendar terms. In FIG. 11, the five vertical bars represent five academic terms (T1-T5, representing 2.5 years with 2 fall and spring terms per year) during which a pilot program was rolled out over three terms, reaching a small number of students in T3 and then all students by T5. In T3, baseline matching is possible since there are more students in the control pool.

The student segmentation unit 1002 segments students by data footprint to produce student segments. The feature ranker 1004 then ranks features in each segment and success metric, such as, but not limited to, persistence, graduation, and job success. The results from these components ensure that there are personalized student success predictors that can be used for matching later. For example, new students don't have institutional features yet, mostly characterized by background features. On the other hand, experienced students have a lot of institutional features, such as GPA, credits earned, degree program alignment score, enrollment patterns, etc. Students enrolled in online courses have even more features derived from their online activities captured through the Learning Management System (LMS). Such data patterns help to identify student segments with students in each segment sharing unique data characteristics. The feature ranker 1004 can perform combinatorial feature ranking leveraging Bayesian Information Criterion to derive top features for each segment.

The matching time-period decision unit decides on time-period matching. As an example, in the term T3 in FIG. 11, baseline matching is possible since there are more students in the control pool. On the other hand, the time period deciding unit 1006 must resort to pre-post matching for T5 since everyone is participating in the intervention program. If there is seasonal variation in student success metrics, the time period deciding unit 1006 may use T1 for clean pre-post matching or a combination of T1 and T3 for mixed-term matching. On T4, the time period deciding unit 1006 performs mixed matching using students in T4 and T2, while preferring those in T4 since T4 represents baseline matching.

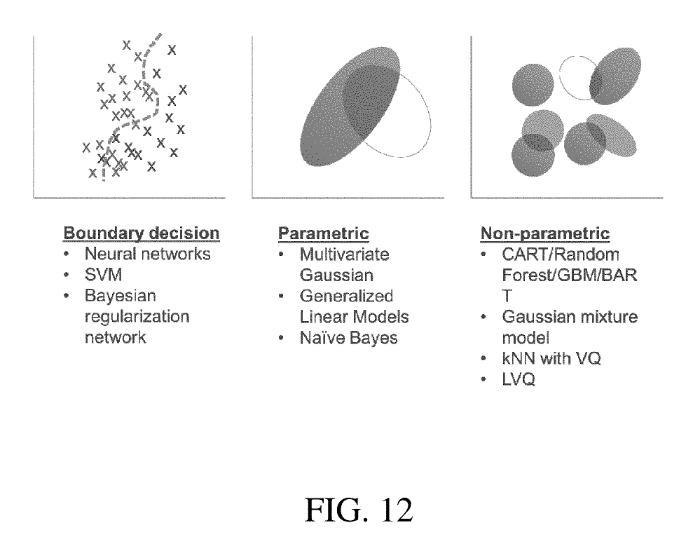

After deciding on features and academic terms for matching, the model builder 1008 builds both predictive and propensity-score models for each student-success metric and intervention program. Using segment-level top predictors, the model builder 1008 first builds student success predictive models, such as, but not limited to, term-to-term persistence. Next, using the same segment-level top predictors, the model builder 1008 builds models to predict student participation in treatment or intervention. The outputs of these models are called prediction and propensity scores, respectively. The actual models are selected adaptively by extracting meta features on good-feature distributions and then mapping meta features to learning algorithms optimized for them, some of which are shown in FIG. 12 as boundary decision, parametric and non-parametric learning algorithms. The parametric learning algorithms make specific statistical assumptions about the underlying good features and estimates parameters associated with those statistical assumptions. On the other hand, non-parametric learning algorithms make no such strong statistical assumptions and leverages more sophisticated algorithms to learn patterns in data. Boundary-decision learning algorithms use a number of input, hidden, and output layers to estimate hyper-dimensional, nonlinear boundary functions to separate various classes of interest. Meta features describe the underlying good feature distributions, such as, but not limited to, modes, degree of overlap, nonlinearity of boundary functions between classes, and shape statistics, such as mean, standard deviation, skewness, and kurtosis.

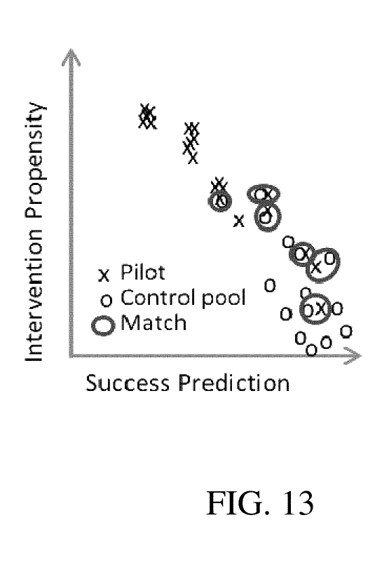

The flexible matching unit 1010 performs matching students in different terms, such as semesters or quarters, using prediction scores, propensity scores, and customer-specified hard-matching covariates, such as cohorts and grad/undergrad, to ensure that the computed pilot and control students are virtually indistinguishable in a statistical sense. FIG. 13 shows a simple threshold-based matching in success prediction and intervention propensity dimensions, which is the essence of PPSM. In an embodiment, covariate matching may be performed followed by PPSM in order to provide maximum flexibility in matching.

The final impact result is the difference in actual outcomes between pilot and control and then adjusted the difference by the difference in predicted outcomes between pilot and control, which in most instances is very close to 0 due to matching. The statistical hypothesis testing unit 1012 uses a number of hypothesis tests, such as, but not limited to, t-test, Wilcoxon rank-sum, and other tests to determine if the final impact result in student success rates between the pilot and control groups is statistically significant.

The same analysis can be repeated for each hypercube, providing more nuanced information on what works for which students under what context, which will then be inserted into the evidence-based action knowledge database 102. First, each CPT cell or Rubik's hypercube is examined. For each hypercube, the same PPSM matching with additional matching is performed in a flexible manner based on the customer's preference or specification. Flexible matching in this context means that the matching is configured to accommodate any customer-specified covariates in hard or covariate matching using the Mahalanobis distance prior to PPSM. Finally, the same statistical hypothesis testing is performed to estimate impact number for each hypercube.

The impact result packaging unit 1014 then packages the impact results of the analyses in a database table consisting of institutional characteristics, intervention program characteristics, overall and drill-down impact results with CPT cell descriptions, student count, statistical significance, and time, and inserts the packaged results into the evidence-based action knowledge database 102.

The following is a description of how the evidence-based action knowledge database (EAKD) 102 can be used to build and deploy the student engagement and impact prediction models by the student impact prediction sub-system 102. The EAKD 102 has action results in multiple levels of abstraction with the following details:
1. Tier-1 results: Engagement rules 4 micro interventions 4 KPIs at student level
   a. Student information
   b. Engagement rules that trigger micro interventions
   c. Micro interventions
   d. Results in tier-1 student success metrics: changes in KPIs
2. Tier-2 results: Exposure-to-treatment impact using dynamic prediction-based propensity score matching at treatment level for student micro segments
   a. Student information
   b. Statistics on engagement rules that trigger micro interventions
   c. Statistics on micro interventions
   d. Results in tier-2 student success metrics: time-dependent changes between pilot and control in (1) prediction scores, (2) engagement scores, (3) Learning Management System (LMS) activities in online courses, (4) time-series activity velocity features, and (5) inferred behavioral and non-cognitive attributes
3. Tier-3 results: Program-level overall and drill-down impact at program level for student segments
   a. Institution information
   b. Intervention program information
   c. Student information
   d. Results in tier-3 student success metrics

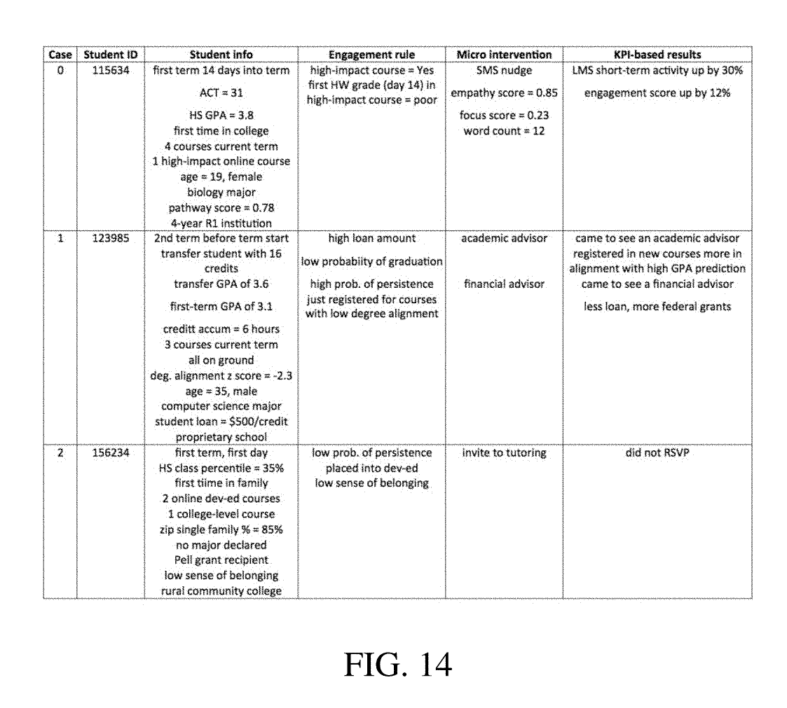

From the tier-1 results, the student impact prediction subsystem 104 builds models to predict changes in KPIs at the student level, using student information, engagement rules, and micro-intervention characteristics, as shown in FIG. 14, which shows representative data samples from the tier-1 impact analysis module 120 that can be used to build student engagement and impact models.

Before further describing the student impact prediction subsystem 104, student engagement and impact are first defined. Student engagement means that the student, upon receiving a micro intervention, followed up within a short period of time with changes in behaviors and activities highly associated with student success. That is, short-term KPI-based results can serve as a proxy for student engagement. Student impact is defined as changes in student success outcomes at the micro-segment level in Rubik's hypercube, where medium-term and long-term student success outcomes encompass, but not limited to, course grade, persistence, graduation, and employment/salary.

The student-engagement model in the student engagement prediction module 116 y_{E}=f(x) has the following attributes:
1. The dependent variable y_{E}=utility score derived from KPI-based short-term results
2. Independent variables x=student information+engagement rules expressed in factor (rule attributes) variables with binary or continuous values+micro interventions expressed in terms of their characteristics and delivery modality
3. Learning algorithm f(·)=any parametric or nonparametric regression algorithm that learns relationships between x and y

The student-impact model operates at the student micro-segment level, as causal impact inferences need to be made at a group level. The Rubik's hypercube is a repository of impact numbers as a function of, but not limited to, student type, engagement rules, micro interventions, institution type, etc. As a result, this model is a lookup table.

The evidence-based action knowledge database (EAKD) 102 stores tier-1, tier-2, and tier-3 impact results to promote the development and retraining of student-engagement and student-impact prediction models. The EAKD 102 facilitates database query using natural language and/or user interface (UI) based search to accelerate the path from predictive insights to actions to results. Furthermore, the EAKD 102 keeps growing as new results are automatically inserted from the three-tier impact analysis subsystem 108 and manually from published pilot results that meet certain requirements.

In an embodiment, the EAKD table schema is structured as follows:
1. General information
   a. Institution information: This table is used to find similar institutions and updated once per term.
   b. Student success program: This table stores program-level information. It is a transactional table at a term level as many of these programs are ongoing.
2. Engagement rule (ER), KPI, and student success metrics
   a. Feature description: This table provides detailed information on student-career-term-day and student-career-term-day-section features used in building various prediction and propensity-score models.
   b. Event description: This table describes event-based features.
   c. Engagement rules: This table stores all engagement rules expressed in terms of rules attributes, operators, operands, thresholds, and set functions for those with multiple attributes.
   d. KPIs: This table collects KPIs that can be used to assess short-term efficacy of micro interventions.
   e. Student success metrics: This table provides detailed information on various student success metrics in evaluating program impact.
   f. Engagement rule-to-KPI mapping: This table maps engagement rules to KPIs so that there is one-to-many mapping for automated tier-1 impact analysis.
3. Micro intervention content
   a. Automated: mapped to engagement rules
      i. Nudges
      ii. Micro surveys with real-time feedback
      iii. Polls with specific response types
   b. Human: situation-dependent talk/email track
      i. Call scripts
      ii. Email templates
4. Reference
   a. Student success program taxonomy
   b. Student taxonomy to describe students
   c. Micro intervention taxonomy
   d. Engagement rule and KPI taxonomy
   e. Institution taxonomy
5. Impact analysis specification for each student success program
   a. Type of experiment: Randomized Controlled Trial (RCT), Quasi-experimental Designor (QED), or Regression Discontinuity Design (RDD)
   b. Unit of separation: explains how pilot and control groups are separated along the student, faculty, course, section, and academic program/major dimensions
   c. Student success metrics: can accommodate multiple metrics
   d. Matching type: baseline, pre-post, hybrid—can be inserted at time of analysis based on population analysis
   e. Hard-matching covariates (if any): The default will be null, but each institution can specify must-match covariates for personalization.
6. Impact results
   a. Matching performance: This table shows the overall matching performance for pilot and control groups with the following data for each success metric.
      i. Model segment encoding as part of data adaptive segmentation
      ii. Covariates used in PPSM matching
      iii. Hard-matching covariates
      iv. Segment-level match statistics
      v. PDFs of pilot-control prediction- and propensity-scores
   b. Tier-3 impact results: This table stores tier-3 Rubik's hypercube or CPT cell consisting of
      i. Tier-3 hypercube encoding
      ii. Student success results for each hypercube with p values (measure of statistical significance) and the number of students along with hypercube description
   c. Tier-2 impact results:
      i. Tier-2 hypercube encoding, such as CPT cell features and their values for each cell
      ii. Dynamic feature and prediction score change results for each hypercube with p values (measure of statistical significance) and the number of students
      iii. Correlation coefficients between tier-2 and -1 impact metrics
   d. Tier-1 impact results:
      i. Tier-1 hypercube encoding
      ii. Utility scores corresponding to tier-1 hypercube with p values (measure of statistical significance) and the number of students Correlation coefficients between tier-3 and -2/-1 impact metrics
   e. Literature results: This table stores published results of various student success programs if they meet certain requirements.

This EAKD structure facilitates algorithm-driven recommendation, natural language search, and UI-based query of appropriate student success programs for institutions.

Lastly, the lifecycle management module 110 operates to create, delete, and update these evidence-based action knowledge base since their relevance and effectiveness may change over time due to changing demographics, underlying economic trends brought upon by new technologies and skills required, and new legislations/regulations. The lifecycle management module 110 tracks impact results across comparable programs over time, looking for consistent results that can be duplicated across multiple, similar institutions. For those programs with inconsistent and/or statistically insignificant results, the lifecycle management module 110 will delete them over time. Furthermore, working with internal stakeholders at higher-education institutions, new innovations in pedagogies, learning techniques, and teaching innovations can be found, leading to suggested pilots to quantify their efficacies and put those results into the knowledge base.

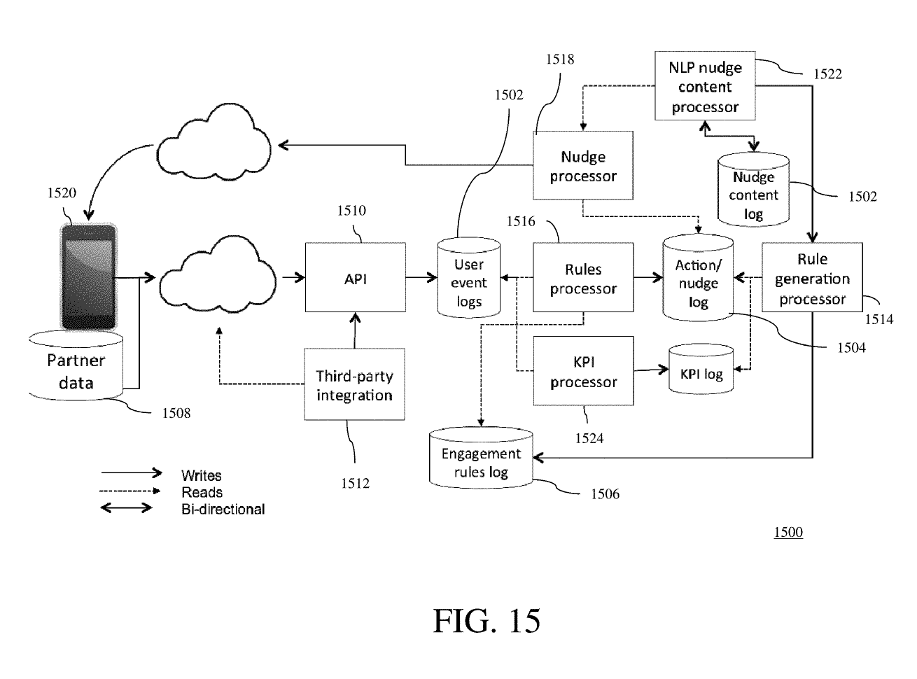

Turning now to FIG. 15, one implementation of the micro intervention delivery subsystem 106 in accordance with an embodiment of the invention is shown as a nudge delivery subsystem 1500. The nudge delivery subsystem 1500 uses incoming event data streams from multiple student event data sources, such as, but not limited to, SIS, LMS, CRM, card swipe, smartphones of students, and surveys to delivery message nudges to students at opportune times.

The incoming event data stream consists of passive sensing data with student opt-in and institutional data consisting of, but not limited to, SIS, LMS, CRM, card swipe data, and location beacon data. A user event log 1502 contains student event data stream (timestamped records of student activity). A nudge log 1504 contains triggered nudges or messages to be delivered to particular students at specific times based on engagement rules being fired. An engagement rules log 1506 contains rule status change as part of rules lifecycle management based on the utility scores of the rules in use, as well as new rules being created working in concert with student success coaches. In this context, a rule represents a set of conditions that specify when to send a particular nudge to a particular student. That is, a rule is a mathematical expression of when to engage students using an appropriate subset of streaming event data and derived features. Each rule is made up of two parts: the event trigger, which links a particular sort of event to a particular nudge response, and a contextual condition, which can further limit a rule's effect by requiring that certain things be true at the time of the event (e.g., low engagement, low attendance).

As illustrated in FIG. 15, partner data 1508 encompassing various enterprise data from colleges and universities are ingested through an Application Programming Interface (API) 1510 that leverages third-party plugin tools 1512, especially for data sources managed through enterprise platform vendors' cloud services.

These multiple-data streams are converted into user-centric time series event data that adhere to defined entity-event taxonomies and stored as the user event logs 1502 so that open-source tools that target such data schema can be leveraged. Furthermore, various digital signal processing algorithms are applied to derive time-series features, such as, but not limited to, course-taking patterns over time, grade trends over n-tiles of courses by their impact scores by graduation, and degree program alignment score that computes how closely the students are following the modal pathways of the successful students in their chosen majors.

A rule generation processor 1514 manages the set of active rules by choosing from a large catalog of predefined rules aided by short-term impact analysis in computing the rules' utility or efficacy scores. The rule generation processor 1514 evaluates a rule's effectiveness by measuring the extent to which key performance indicators (KPIs) associated with the rule for the nudged student are moved in a favorable direction.

A rule processor 1516 joins student events to the larger student context expressed in terms of derived time-series features in order to determine which rules apply to which events, and, correspondingly, which nudges need to be delivered to which students. The rule processor 1516 writes nudges it determines need to be delivered to the nudge log 1504. The priority is based on the utility function, which is computed as a function of engagement rules, KPIs, and student micro-segments.

A nudge processor 1518 reads from the nudge log 1504 and sends messages to students using customer-specified modalities, encompassing, but not limited to, SMS/MMS, email, push notification, automated voice calls, and in-person calls, which may be provided to smartphone 1520 of the students.

A natural language process (NLP) nudge content processor 1522 reads from the nudge content log 1502, performs NLP to encode nudge content parameters along with multi-polarity sentiments, and then stores nudge parameters back to the nudge content log while providing the same parameters to the rule generation processor 1514 so the effectiveness of engagement rules can be assessed in connection with delivered nudges.

A KPI processor 1524 computes aggregate metrics from student event data and writes these data to a KPI log 1526. These metrics encompass changes in KPIs mapped to engagement rules post nudging using short-term impact analyses, as explained above. These metrics are computed as a function of engagement rules, KPIs, and student characteristics.

The nudge delivery subsystem 1500 may be implemented using one or more computers and computer storages. The various logs of the nudge delivery subsystem 1500 may be stored in any computer storage, which is accessible by the components of the nudge delivery subsystem 1500. The components of the nudge delivery subsystem 1500 can be implemented as software, hardware or a combination of software and hardware. In some embodiments, at least some of these components of the nudge delivery subsystem 1500 are implemented as one or more software programs running in one or more computer systems using one or more processors and memories associated with the computer systems. These components may reside in a single computer system or distributed among multiple computer systems, which may support cloud computing.

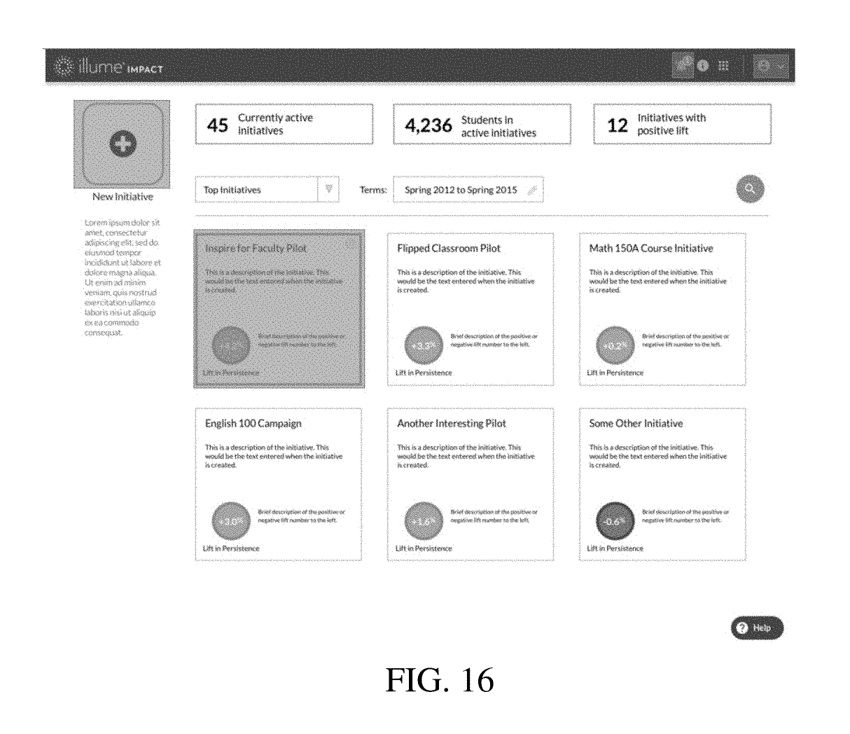

FIG. 16 depicts a homepage that illustrate how such connected, predictive, and action insights can be communicated to various stakeholders to create a virtuous circle in accordance with an embodiment of the invention. The product home page in FIG. 16 shows a number of active student success initiatives along with the number of students touched through these initiatives and the number of initiatives showing statistically significant positive impact. In the home page of FIG. 16, a user can upload a new initiative using the + icon on the upper left-hand corner. This will open a new page guiding the user through the intervention data preparation and upload processes. The main body of the home page consists of a number of analyzed student success initiatives, with summary statistics. The user can click on each initiative icon to open a drill-down view for more details on the initiative.

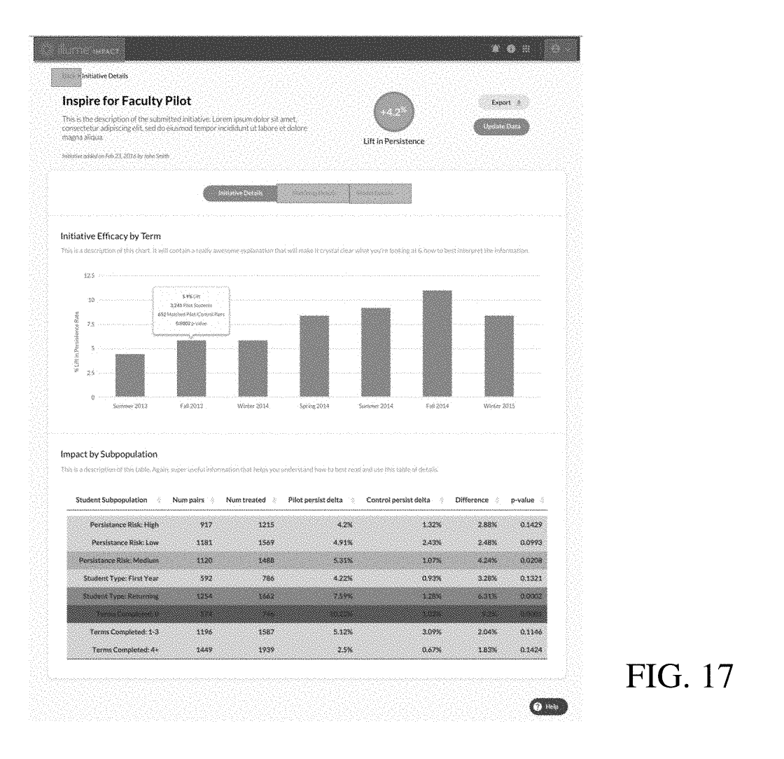

FIG. 17 depicts a drill-down initiative page in accordance with an embodiment of the invention. The drill-down initiative page shows the overall statistics at the top. The drill-down initiative page also displays the initiative impact by time and by student segments. The drill-down impact numbers can help the customer optimize and continuously improve initiative operations.

In summary, the student data-to-insight-to-action-to-learning analytics system 100 provides feature extraction that treats time-series multi-channel event data at various sampling rates as linked-event features at various levels of abstraction for both real-time actionability and context, which then leads to the three-level predictions of when (engagement) to reach out to which students with what interventions for high-ROI impact.

The analytics system 100 also provides three-tier impact analysis that resolves results-attribution ambiguity through micro-pathway construction between actions and results, which serves as an engine to both engagement and impact predictions.

The analytics system 100 also provides the evidence-based action knowledge database that can be used to provide a graphical representation on the efficacy of various initiative strategies as a function of a student's attributes, context, and intervention modalities, which is the backbone of impact prediction.

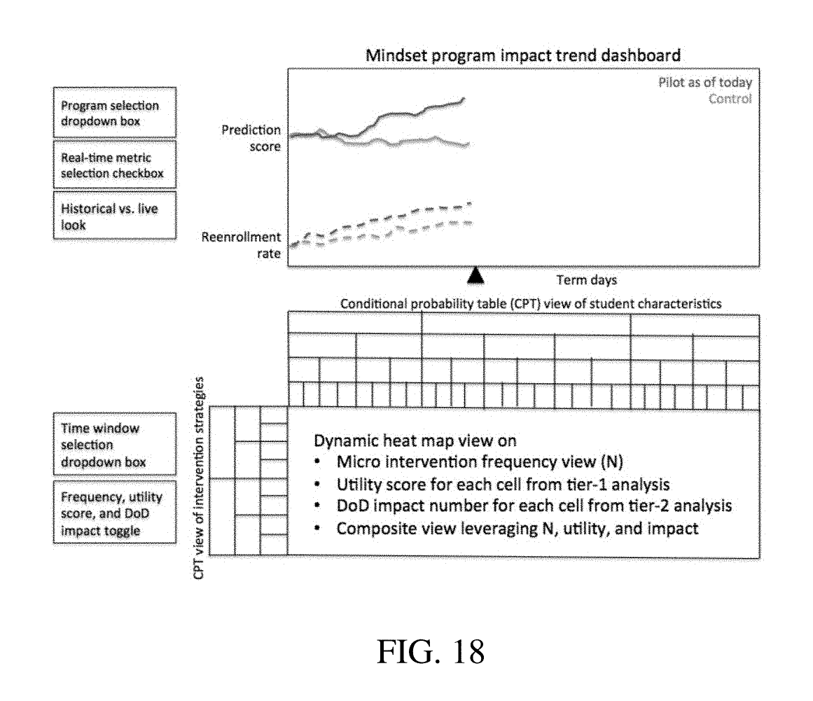

The analytics system 100 can also provide a real-time student success program impact dashboard that provides the nuanced view of how well the program is working using the three-tier impact analysis results. An example dashboard is depicted in FIG. 18, which encompasses customizations to select programs, display any combination of real-time impact metrics, and see results in different time periods. Furthermore, the customizable two-dimensional conditional probability table (CPT) view gives the student-success stakeholders a comprehensive overview of what is working and how they can improve student-success operations continuously.

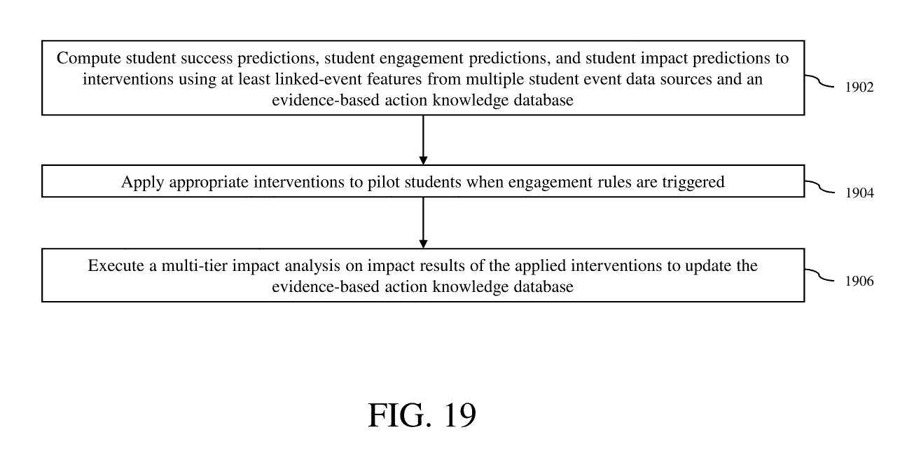

A student data-to-insight-to-action-to-learning (DIAL) analytics method in accordance with an embodiment of the invention is now described with reference to the process flow diagram of FIG. 19. At block 1902, student success predictions, student engagement predictions, and student impact predictions to interventions are computed using at least linked-event features from multiple student event data sources and an evidence-based action knowledge database. The linked-event features include student characteristic factors that are relevant to student success. At block 1904, appropriate interventions are applied to pilot students when engagement rules are triggered. The engagement rules are based on at least the linked-event features and multi-modal student success prediction scores and may be customized to address each institution's unique situations as well as common issues that affect many similar institutions. At block 1906, a multi-tier impact analysis on impact results of the applied interventions is executed to update the evidence-based action knowledge database. The multi-tier impact analysis includes using changes in key performance indicators (KPIs) for the pilot students after each applied intervention and dynamic matching of the pilot students exposed to the appropriate interventions to other students who were not exposed to the appropriate interventions

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blue-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

### REFERENCES

1. M. Sullivan, “Awash in Data, Thirsting for Truth,” The NY Times, Sep. 5, 2015.
2. J. C. Greene, “Method and system for delivery of healthcare services,” U.S. Pat. No. 7,925,519, Apr. 12, 2011.
3. A. R. Feinstein, “Problems in the “Evidence” of “Evidence-Based Medicine,” The American Journal of Medicine, Vol. 103, No. 6, pp. 529-535, December 1997.
4. S. H. Woolf, et al., “Potential benefits, limitations, and harms of clinical guidelines,” BMJ, Vol. 318, No. 7182, pp. 527-530, February 1999.
5. J. loannidis, “Why Most Published Research Findings Are False,” PLOS Medicine, Vol. 2, No. 8, August 2005.
6. Littell, J. H. “Evidence-based or Biased? The Quality of Published Reviews of Evidence-based Practices.” Children and Youth Services Review, Vol. 30, No. 11, pp. 1299-1317, 2008.
7. F. Song, et al., “Dissemination and publication of research findings: an updated review of related biases,” Health Technology Assessment, Vol. 14, No. 10, 2010.
8. WWC, http://ies.ed.gov/ncee/wwc/, accessed in January 2016.
9. D. Kil, et al., “Data-adaptive insight and action platform in higher education,” US Patent Application 20150193699, July 2015.
10. J. James, “Health Policy Brief: Patient Engagement,” Health Affairs, Feb. 14, 2013.
11. A. Gawande, “The Hot Spotters,” The New Yorker, Jan. 24, 2011.
12. G. Fahner, “Causal Modeling for Estimating Outcomes Associated with Decision Alternatives,” U.S. Pat. No. 8,682,762, March 2014.
13. P. R. Rosenbaum and R. B. Rubin, “The Central Role of the Propensity Score in Observational Studies for Causal Effects,” MRC Technical Summary Report #2305, December 1981.
14. D. Kil, “Intelligent health benefit design system,” U.S. Pat. No. 7,912,734, March 2011.

What is claimed is:

1. A student data-to-insight-to-action-to-learning analytics method comprising:
computing student success predictions, student engagement predictions, and student impact predictions to interventions using at least linked-event features from multiple student event data sources and an evidence-based action knowledge database, the linked-event features including student characteristic factors that are relevant to student success;
applying appropriate interventions to pilot students when engagement rules are triggered, the engagement rules being based on at least the linked-event features and multi-modal student success prediction scores; and
executing a multi-tier impact analysis on impact results of the applied interventions to update the evidence-based action knowledge database, the multi-tier impact analysis including using changes in key performance indicators (KPIs) for the pilot students after each applied intervention and dynamic matching of the pilot students exposed to the appropriate interventions to other students who were not exposed to the appropriate interventions.

2. The method of claim 1, wherein executing a multi-tier impact analysis includes computing utility scores for triggered engagement rule-intervention pairs by looking at changes in KPIs within a defined time window.

3. The method of claim 2, wherein executing a multi-tier impact analysis further includes determining whether the interventions are message nudges, and for the message nudges, performing natural language processing on the contents of the message nudges to learn characteristics of effective and ineffective messages.

4. The method of claim 1, wherein applying the appropriate interventions to the pilot students further comprises:
monitoring incoming streams of event data to detect when any of the engagement rules are triggered;
if more than one engagement rule is triggered, prioritizing the engagement rules that are triggered based corresponding utility scores and intersection with recently triggered engagement rules to derive a highest ranked engagement rule; and
applying an intervention that correspond to the highest ranked engagement rule to at least one pilot student.

5. The method of claim 3, wherein executing a multi-tier impact analysis includes:
aligning the applied interventions with respect to time;
creating a pool of control students that are similar to each pilot student exposed to one of the interventions;
creating groups of pilot and control students that have similar metrics; and
performing difference-of-difference analysis on each applied intervention for the groups of pilot and control students to produce success metrics for cells of CPT.

6. The method of claim 5, wherein executing a multi-tier impact analysis further includes correlating the success metrics with the utility scores.

7. The method of claim 6, wherein executing a multi-tier impact analysis includes:
segmenting the students using data footprint;
selecting features and academic terms for matching:
building predictive and propensity-score models for each student-success metric and intervention program to produce prediction scores and propensity scores;
performing a matching process on the pilot and control students to ensure that the pilot and control students are indistinguishable in a statistical sense; and
executing a statistical hypothesis testing to determine if observed difference in student success rates between the pilot and control students is statistically significant.

8. A computer-readable storage medium containing program instructions for student data-to-insight-to-action-to-learning analytics method, wherein execution of the program instructions by one or more processors of a computer system causes the one or more processors to perform steps comprising:
computing student success predictions, student engagement predictions, and student impact predictions to interventions using at least linked-event features from multiple student event data sources and an evidence-based action knowledge database, the linked-event features including student characteristic factors that are relevant to student success;
applying appropriate interventions to pilot students when engagement rules are triggered, the engagement rules being based on at least the linked-event features and multi-modal student success prediction scores; and
executing a multi-tier impact analysis on impact results of the applied interventions to update the evidence-based action knowledge database, the multi-tier impact analysis including using changes in key performance indicators (KPIs) for the pilot students after each applied intervention and dynamic matching of the pilot students exposed to the appropriate interventions to other students who were not exposed to the appropriate interventions.

9. The computer-readable storage medium of claim 8, wherein executing a multi-tier impact analysis includes computing utility scores for triggered engagement rule-intervention pairs by looking at changes in KPIs within a defined time window.

10. The computer-readable storage medium of claim 9, wherein executing a multi-tier impact analysis further includes determining whether the interventions are message nudges, and for the message nudges, performing natural language processing on the contents of the message nudges to learn characteristics of effective and ineffective messages.

11. The computer-readable storage medium of claim 8, wherein applying the appropriate interventions to the pilot students further comprises:
monitoring incoming streams of event data to detect when any of the engagement rules are triggered;
if more than one engagement rule is triggered, prioritizing the engagement rules that are triggered based corresponding utility scores and intersection with recently triggered engagement rules to derive a highest ranked engagement rule; and
applying an intervention that correspond to the highest ranked engagement rule to at least one pilot student.

12. The computer-readable storage medium of claim 11, wherein executing a multi-tier impact analysis includes:
aligning the applied interventions with respect to time;
creating a pool of control students that are similar to each pilot student exposed to one of the interventions;
creating groups of pilot and control students that have similar metrics; and
performing difference-of-difference analysis on each applied intervention for the groups of pilot and control students to produce success metrics for cells of CPT.

13. The computer-readable storage medium of claim 12, wherein executing a multi-tier impact analysis further includes correlating the success metrics with the utility scores.

14. The computer-readable storage medium of claim 13, wherein executing a multi-tier impact analysis includes:
segmenting the students using data footprint;
selecting features and academic terms for matching:
building predictive and propensity-score models for each student-success metric and intervention program to produce prediction scores and propensity scores;
performing a matching process on the pilot and control students to ensure that the pilot and control students are indistinguishable in a statistical sense; and
executing a statistical hypothesis testing to determine if observed difference in student success rates between the pilot and control students is statistically significant.

15. A student data-to-insight-to-action-to-learning analytics system comprising:
memory;
a processor configured to:
compute student success predictions, student engagement predictions, and student impact predictions to interventions using at least linked-event features from multiple student event data sources and an evidence-based action knowledge database, the linked-event features including student characteristic factors that are relevant to student success;
apply appropriate interventions to pilot students when engagement rules are triggered, the engagement rules being based on at least the linked-event features and multi-modal student success prediction scores; and
execute a multi-tier impact analysis on impact results of the applied interventions to update the evidence-based action knowledge database, the multi-tier impact analysis including using changes in key performance indicators (KPIs) for the pilot students after each applied intervention and dynamic matching of the pilot students exposed to the appropriate interventions to other students who were not exposed to the appropriate interventions.

16. The system of claim 15, wherein the processor is configured to compute utility scores for triggered engagement rule-intervention pairs by looking at changes in KPIs within a defined time window to execute the multi-tier impact analysis.

17. The system of claim 16, wherein the processor is configured to determine whether the interventions are message nudges, and for the message nudges, perform natural language processing on the contents of the message nudges to learn characteristics of effective and ineffective messages to execute the multi-tier impact analysis.

18. The system of claim 15, wherein the processor is configured to:
monitor incoming streams of event data to detect when any of the engagement rules are triggered;
if more than one engagement rule is triggered, prioritize the engagement rules that are triggered based corresponding utility scores and intersection with recently triggered engagement rules to derive a highest ranked engagement rule; and
apply an intervention that correspond to the highest ranked engagement rule to at least one pilot student.

19. The system of claim 18, wherein the processor is configured to:
align the applied interventions with respect to time;
create a pool of control students that are similar to each pilot student exposed to one of the interventions;
create groups of pilot and control students that have similar metrics; and
perform difference-of-difference analysis on each applied intervention for the groups of pilot and control students to produce success metrics for cells of CPT.

20. The system of claim 19, wherein the processor is configured to:
segment the students using data footprint;
selecting features and academic terms for matching:
build predictive and propensity-score models for each student-success metric and intervention program to produce prediction scores and propensity scores;
perform a matching process on the pilot and control students to ensure that the pilot and control students are indistinguishable in a statistical sense; and
execute a statistical hypothesis testing to determine if observed difference in student success rates between the pilot and control students is statistically significant.
